(19) United States
(12) Patent Application Publication
(10) Pub. No.: US 2023/0159266 A1
(43) Pub. Date: May 25, 2023

(54) SYSTEM AND METHOD FOR CONTAINING ODORS AND PROBLEMATIC ITEMS BEING DISPOSED

(71) Applicant: Lynda GATTOZZI, Bethesda, MD (US)

(72) Inventor: Lynda GATTOZZI, Bethesda, MD (US)

(21) Appl. No.: 17/531,702

(22) Filed: Nov. 19, 2021

(51) Int. Cl. B65F 1/04; B65F 1/00

(52) U.S. Cl. CPC B65F 1/04; B65F 1/0006; B65F 2210/129

(57) ABSTRACT

A refuse bag and preventative container combination used to eliminate odors or to contain problematic items being disposed of. In use, the odorous garbage or the problematic items are placed within the preventative container and the preventative container is then seal to either reduce or eliminate any odors emanating from the items placed inside or to prevent the items placed inside to escape from the preventative container. The preventative container is then placed inside the refuse bag and the refuse bag can continue to be used until it is full or it is otherwise time to dispose of. Other house problematic items, such as cat litter, animal waste, grease, or similar items can be placed in the preventative container for disposal.

### FIELD OF THE INVENTION

The present invention relates to the field of refuse bags such as kitchen trash bags and similar items.

### BACKGROUND OF THE INVENTION

Each of us is familiar with odorous smells emanating from our kitchen trash bags and similar refuse containers. In addition, there are many other types of refuse that is placed into trash bags, such as kitchen trash bags, which cause concern or problems. For example, and without limitation, problems arise when we need to dispose of grease from cooking chop meat or bacon, disposing of used pet materials such as cat litter or bedding for small animals such as hamsters or gerbils. These types of problems have plagued mankind for centuries. People have attempted to eliminate or mask these odors through various means such as placing pleasantly smelling devices on the inside of the garbage container, placing anything that may smell in the freezer until garbage day and/or removing the trash from the kitchen on a daily basis.

### SUMMARY OF THE INVENTION

A refuse bag and preventative container combination including a refuse bag with a first capacity, at least one preventative container removably attached to the refuse bag wherein a capacity of the preventative container is less than the first capacity of the refuse bag and wherein the preventative container includes at least one property that the refuse bag does not possess.

### BRIEF DESCRIPTION OF THE DRAWINGS

In the drawings, like reference characters refer to the same parts throughout the different views. The drawings are not necessarily drawn to scale, the emphasis of the drawings is being placed upon illustrating the principles of various embodiments of the invention. The foregoing and other aspects of the invention will be better understood from the following description of embodiments of the invention, by way of example only, and with reference to the accompanying drawings, in which:

FIG. 1 is an illustration of one embodiment of a refuse bag with preventative containers; and

FIG. 2 is an illustration of one embodiment of a preventative container.

### DETAILED DESCRIPTION OF THE INVENTION

In the following detailed description, reference will be made in detail to the embodiments of the present invention, examples of which are illustrated in the accompanying drawings, which form a part hereof and show by way of illustration embodiments in which the invention may be practiced. These embodiments are described in sufficient detail to enable those skilled in the art to practice the invention, and it is to be understood that other embodiments may be utilized, and that structural, and logical changes may be made without departing from the spirit and scope of the present invention. The progression of processing steps described (if any) is exemplary of embodiments of the invention; however, the sequence of steps is not limited to that set forth herein and may be changed as is known in the art, except for steps necessarily occurring in a certain order.

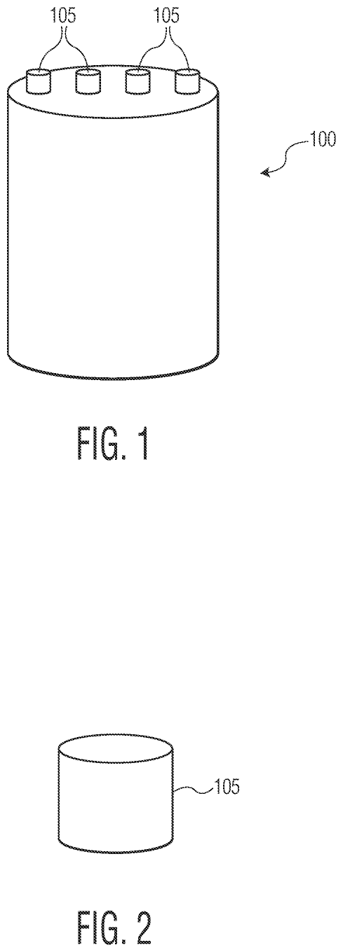

FIG. 1 shows one embodiment of a refuse bag 100 with preventative containers 105. In different embodiments of the present invention, the preventative containers may be: (a) positioned along the entire inside circumference of the refuse bag, (b) positioned along a portion of the circumference of the refuse bag, or (c) layered on top of each other on one portion of the inside circumference of the refuse bag 100. In other embodiments, the preventative containers 105 may be located: (d) along the entire outside circumference of the refuse bag, (e) along a portion of the outside circumference of the refuse bag, or (f) layered on top of each other on a single portion of the outside circumference of the refuse bag. In each instance the preventative container is removably attached to either the refuse bag 100 or to another preventative container. In some embodiments, different types of preventative containers 105 may be positioned along different parts of the refuse bag 100. In some embodiments the refuse bag 100 is a kitchen trash bag. In other embodiments, the refuse bag 100 is a larger garbage bag. One of ordinary skill in the art would appreciate that the preventative containers 105 may be located at different points of the refuse bag 100 without deviating from the spirit of the invention.

FIG. 2 shows one embodiment of a preventative container 105. Preventative container 105 may have several different properties, including but not limited to stopping odors, containing liquids without leaking, or withstanding high temperatures. In its simplest form, preventative container 105 may just be a small plastic bag with a method to securely close the top portion of the plastic bag. In other forms, preventative container 105 may be composed of leakproof material, may be composed of plastic material which can withstand higher temperatures, or the material may be coated with a pleasant smelling fragrance to help mask the odor of whatever is contained within the preventative container 105, or the preventative container may be coated with specific type of material or chemical to counteract the smell of specific items. In some embodiments, preventative containers with different properties may be attached to the same refuse bag 100. For example, and without limitation, if the refuse bag 100 takes the form of a kitchen trash bag, a variety of preventative containers may be attached. For example, several preventative containers to house food debris may be attached while other preventative containers used to hold items such as grease from cooking may also be attached. In some embodiments, the preventative containers may have a special coating to eliminate the smell of used cat litter. In other instances, the preventative containers may have a special coating to eliminate the smell of dog poop or materials used for pets such as shavings for a hamster or gerbil cage.

In all instances the capacity of the preventative container is less than the capacity of the refuse bag. For example, and without limitation, if the capacity of the refuse bag is 38 liters, the capacity of each of the preventative containers would be less than 20 liters.

In use, the odorous garbage or the problematic items are placed within a preventative container and the preventative container is then seal to either reduce or eliminate any odors emanating from the items placed inside or to prevent the items placed inside to escape from the preventative container. The preventative container is then placed inside the refuse bag and the refuse bag can continue to be used until it is full or it is otherwise time to dispose of refuse bag containing one or more preventative containers. Other house problematic items, such as cat litter, animal waste, grease, or similar items can be placed in the preventative container for disposal at a later time.

While the invention has been particularly shown with reference to specific embodiments, it should be understood by those of ordinary skill in the art that various changes in form and detail may be made therein without departing from the spirit and scope of the invention as defined by the claims. The invention is to cover all modifications, equivalents, and alternatives falling within the spirit and scope of the invention as defined by the claims.

1. A refuse bag and at least two preventative plastic containers combination including:
a refuse bag with a first capacity,
at least two preventative plastic containers removably attached to said refuse bag wherein a capacity of said at least two preventative plastic containers is less than the first capacity of the refuse bag and wherein each of said at least two preventative plastic containers includes at least one property that said refuse bag does not possess.

2. The refuse bag and at least two preventative plastic containers of claim 1 wherein each of the at least two preventative plastic containers can be individually sealed and detached from said refuse bag at the time of use to reduce the amount of odor emanating from each of said at least two preventative plastic containers.

3. The refuse bag and at least two preventative plastic containers of claim 1 wherein each of said at least two preventative plastic containers can be individually sealed at the time of use to contain a liquid substantially without leakage.

4. The refuse bag and at least two preventative plastic containers of claim 1 wherein each of said at least two preventative plastic containers is composed of material which can stand temperatures above 100 degrees Fahrenheit.

5. The refuse bag and at least two preventative plastic containers of claim 1 wherein an inside of each of said at least two preventative plastic containers is coated to reduce an odor of a material placed inside each of said preventative plastic containers.
